(19) United States
(12) Patent Application Publication
(10) Pub. No.: US 2025/0162760 A1
(43) Pub. Date: May 22, 2025

(54) PALLET AND LOADING SYSTEM

(71) Applicant: SINTOKOGIO, LTD., Nagoya-shi (JP)

(72) Inventors: Yoshikane TANAAMI, Nagoya-shi (JP); Yukie MAENO, Nagoya-shi (JP); Miyuki HAYASHI, Nagoya-shi (JP)

(73) Assignee: SINTOKOGIO, LTD., Nagoya-shi (JP)

(21) Appl. No.: 18/813,619

(22) Filed: Aug. 23, 2024

(30) Foreign Application Priority Data
Nov. 22, 2023 (JP) 2023-198286

(51) Int. Cl. B65D 19/38; B65D 19/00

(52) U.S. Cl. CPC B65D 19/38; B65D 19/0002; B65D 2201/00; B65D 2519/00776

(57) ABSTRACT

To provide a pallet that makes it possible to prevent load shifting in a case where the pallet inclines. A pallet includes: an upper plate on which a load is to be placed; a lower frame disposed so as to face the upper plate; at least three force sensors disposed on a lower surface of the upper plate or an upper surface of the lower frame; at least three raising and lowering mechanisms that are disposed between the upper plate and the lower frame via the at least three force sensors and that are able to raise and lower the upper plate with respect to the lower frame; and a controller configured to perform control to drive the at least three raising and lowering mechanisms on the basis of output signals from the at least three force sensors.

This Nonprovisional application claims priority under 35 U.S.C. § 119 on Patent Application No. 2023-198286 filed in Japan on Nov. 22, 2023, the entire contents of which are hereby incorporated by reference.

### TECHNICAL FIELD

The present invention relates to a pallet and a loading system.

### BACKGROUND ART

Patent Literature 1 discloses a pallet for forklifts which is provided with (i) an insertion hole into which the fork of a forklift that extends forward is to be inserted and which penetrates through the pallet and (ii) a mark which can be recognized by a driver and which is formed in the vicinity of an entry of the insertion hole.

### CITATION LIST

### Patent Literature

[Patent Literature 1]
Japanese utility model registration No. 3232641

### SUMMARY OF INVENTION

### Technical Problem

When a load is loaded on such a pallet for forklifts, giving no consideration to the weight of the load and the center of gravity of the entire pallet may lead to an imbalance of the center of gravity of the entire pallet. This may result in load shifting during transportation by, for example, a forklift. In addition, when a vehicle, such as a truck, which is carrying the pallet travels on a sloping road, the loading space may incline and cause load shifting.

An aspect of the present invention has been achieved in light of the foregoing problem, and it is an object thereof to provide a pallet and a loading system each of which makes it possible to prevent load shifting in a case where the pallet inclines.

### Solution to Problem

In order to solve the foregoing problem, a pallet in accordance an aspect of the present invention includes: an upper plate on which a load is to be placed; a lower frame disposed so as to face the upper plate; at least three force sensors disposed on a lower surface of the upper plate or an upper surface of the lower frame; at least three raising and lowering mechanisms that are disposed between the upper plate and the lower frame via the at least three force sensors and that are able to raise and lower the upper plate with respect to the lower frame; and a controller configured to perform control to drive the at least three raising and lowering mechanisms on the basis of output signals from the at least three force sensors.

### Advantageous Effects of Invention

According to an aspect of the present invention, a controller makes it possible to, in a case where a pallet in which a load is placed on an upper plate thereof inclines, make the upper plate closer to a horizontal state by performing control to drive at least three raising and lowering mechanisms on the basis of output signals from at least three force sensors. As a result, the controller makes it possible to prevent load shifting in a case where the pallet inclines.

### BRIEF DESCRIPTION OF DRAWINGS

FIG. 1 is a perspective view illustrating an example of a schematic configuration of a pallet in accordance with Embodiment 1.

FIG. 2 is a plan view illustrating an example of a schematic configuration of the pallet in accordance with Embodiment 1.

FIG. 3 is a perspective view illustrating an example of a raising and lowering mechanism.

FIG. 4 is a block diagram illustrating an example of an electrical configuration of the pallet in accordance with Embodiment 1.

FIG. 5 is a flowchart illustrating an example of an upper-plate raising-and-lowering control process executed by a controller.

FIG. 6 is a front view illustrating an example of the center of pressure on the pallet in a horizontal state.

FIG. 7 is a front view illustrating an example of the center of pressure on the pallet in an inclined state.

FIG. 8 is a view schematically illustrating an example of an operation of the pallet placed on a loading space of a truck.

FIG. 9 is an explanatory view for explaining a schematic configuration of a loading system in accordance with Embodiment 2.

FIG. 10 is a block diagram illustrating an example of an electrical configuration of the loading system in accordance with Embodiment 2.

FIG. 11 is a flowchart illustrating an example of a loading control process executed by the loading control device in accordance with Embodiment 2.

FIG. 12 is a flowchart illustrating an example of a force-sensor output process executed by a robot controller in accordance with Embodiment 2.

FIG. 13 is a flowchart illustrating an example of a center-of-pressure output process executed by a controller of a pallet in accordance with Embodiment 2.

### DESCRIPTION OF EMBODIMENTS

The following will describe Embodiment 1 and Embodiment 2, in each of which embodies the present invention, with reference to the drawings in detail. The same or similar constituent elements and members depicted in the drawings are given the same reference numerals, and the same descriptions are omitted as appropriate.

### Embodiment 1

### [Schematic Configuration of Pallet 1]

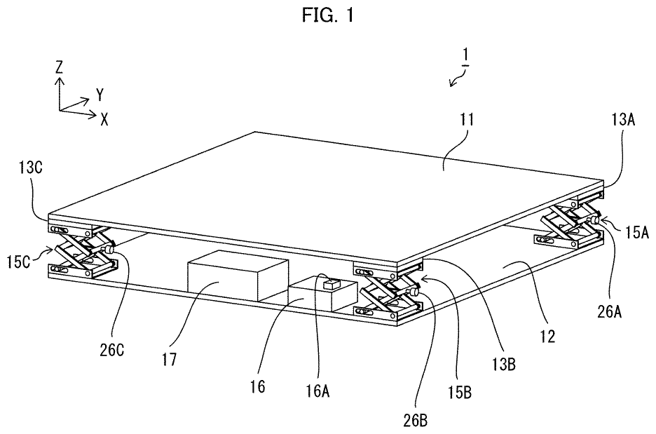

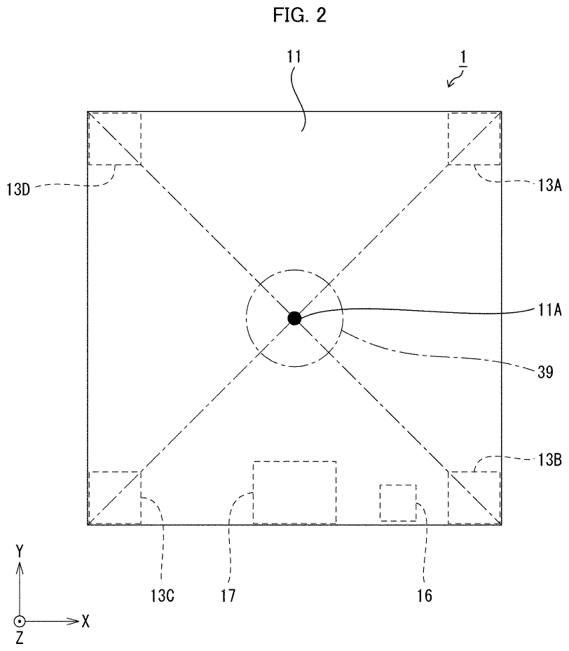

First, with reference to FIG. 1 and FIG. 2, the following description will discuss a schematic configuration of a pallet 1 in accordance with Embodiment 1 of the present disclosure. FIG. 1 is a perspective view illustrating an example of the schematic configuration of the pallet 1 in accordance with Embodiment 1. FIG. 2 is a plan view illustrating an example of the schematic configuration of the pallet 1 in accordance with Embodiment 1. As illustrated in FIG. 1 and FIG. 2, the pallet 1 includes an upper plate 11, a lower frame 12, four force sensors 13A to 13D, four raising and lowering mechanisms 15A to 15D, a controller 16, and a battery 17.

The upper plate 11 is made of wood or resin and is formed into a flat plate shape which is rectangular in plan view. On the upper surface of the upper plate 11, a load is to be placed. To the four corners on the lower surface of the upper plate 11, the force sensors 13A to 13D each having a rectangular shape in plan view and having a predetermined thickness are attached.

The lower frame 12 is made of wood or resin and is formed into a flat plate shape. Further, the lower frame 12 is formed into a rectangular shape in plan view which has a size substantially identical with that of the upper plate 11 and is disposed below the upper plate 11 so as to face the upper plate 11. To the four corners on the upper surface of the lower frame 12, the raising and lowering mechanisms 15A to 15D each of which has a rectangular shape in plan view and has an upper end portion movable in an up-and-down direction are attached. The lower end portions of the force sensors 13A to 13D of the upper plate 11 are attached to the respective upper end portions of the raising and lowering mechanisms 15A to 15D, and the lower frame 12 is attached to the lower surface of the upper plate 11 via the force sensors 13A to 13D and the raising and lowering mechanisms 15A to 15D.

Each of the force sensors 13A to 13D is a three-axis force sensor configured to detect force components FX, FY, and FZ in directions of three axes, namely, X-, Y-, and Z-axes, of a force sensor coordinate system in which the axis direction corresponds to the Z-axis direction. The force sensors 13A to 13D are attached to the lower surface of the upper plate 11 so that the Z-axis direction corresponds to a vertical direction. Note that the force sensors 13 may be each a six-axis force sensor configured to detect the force components FX, FY, and FZ in the directions of the three axes, namely, the X-, Y-, and Z-axes, of the force sensor coordinate system in which the axis direction corresponds to the Z-axis direction and moment components MX, MY, and MZ around the rotational axes which are the three axes, namely, the X-, Y-, and Z-axes.

### [Specific Configuration of Raising and Lowering Mechanisms 15A to 15D]

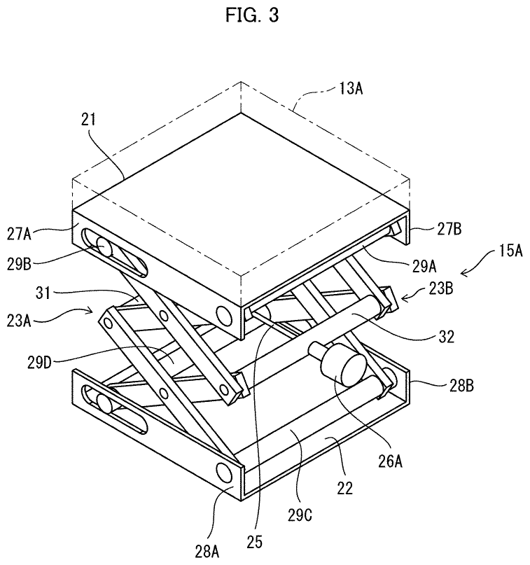

With reference to FIG. 3, the following description will discuss the schematic configuration of the raising and lowering mechanisms 15A to 15D. FIG. 3 is a perspective view illustrating an example of the raising and lowering mechanism 15A. Note that the raising and lowering mechanisms 15A to 15D have the same configuration, and thus the raising and lowering mechanism 15A will be discussed. As illustrated in FIG. 3, the raising and lowering mechanism 15A includes a flat plate-shaped top plate portion 21 having a rectangular shape in plan view, a flat plate-shaped bottom plate portion 22 having a rectangular shape in plan view, paired link mechanisms 23A and 23B disposed so as to face each other, a screw shaft 25, and a motor 26A configured to drive the screw shaft 25 to rotate. Note that the raising and lowering mechanisms 15A to 15D include their respective motors 26A to 26D configured to drive the screw shafts 25 thereof to rotate. The motors 26A to 26D are made up of, for example, a stepping motor or a DC servomotor.

The upper surface of the top plate portion 21 is attached to the lower end surface of the force sensor 13A through, for example, screw fitting, and is attached to the lower surface of the upper plate 11 via the force sensor 13A. The edge portions on both sides of the top plate portion 21 which face the upper end portions of the paired link mechanisms 23A and 23B are provided with upper attachment ribs 27A and 27B protruding so as to be a rib form over the entire widths of the edge portions. In addition, the lower surface of the bottom plate portion 22 is placed on the upper surface of the lower frame 12 and is attached to the upper surface through, for example, screw fitting. The edge portions on both sides of the bottom plate portion 22 which face the lower end portions of the paired link mechanisms 23A and 23B are provided with lower attachment ribs 28A and 28B each protruding so as to be a rib form over the entire widths of the edge portions.

The paired link mechanisms 23A and 23B have a pantograph structure in which paired links with X-shaped structures are stacked in two upper and lower stages and are configured to be coupled so as to be able to change its position through extension and contraction as a whole. Among the upper end portions of the X-shaped structures in the upper stage, the upper end portions on a motor 26A side are fixed to the upper attachment ribs 27A and 27B so as to be rotationally movable, via a support shaft 29A bridging across the paired link mechanisms 23A and 23B. Among the upper end portions of the X-shaped structures in the upper stage, the upper end portions on a side opposite to the motor 26A are engaged with the upper attachment ribs 27A and 27B so as to be slidable parallel to the top plate portion 21, via a support shaft 29B bridging across the paired link mechanisms 23A and 23B.

The lower end portions of the paired links of the X-shaped structures in the upper stage are connected to the respective upper end portions of the paired links of the X-shaped structures in the lower stage so as to be rotationally movable with rotational-movement support members 31 and 32 each bridging across the paired link mechanisms 23A and 23B as fulcrums. Among the lower end portions of the X-shaped structures in the lower stage, the lower end portions on a motor 26A side are fixed to the lower attachment ribs 28A and 28B so as to be rotationally movable, via a support shaft 29C bridging across the paired link mechanisms 23A and 23B. Among the lower end portions of the X-shaped structures in the lower stage, the lower end portions on a side opposite to the motor 26A are engaged with the lower attachment ribs 28A and 28B so as to be slidable parallel to the bottom plate portion 22, via a support shaft 29D bridging across the paired link mechanisms 23A and 23B.

The screw shaft 25 is inserted into and fitted with a screw hole formed in the rotational-movement support member 32 on the motor 26A side. The tip end portion of the screw shaft 25 is rotatably fixed to the rotational-movement support member 31 disposed so as to face the rotational-movement support member 32. Further, to the base end portion of the screw shaft 25, the motor 26A is coupled so as to be able to rotate the screw shaft 25.

Therefore, in the raising and lowering mechanism 15A configured as above, in a case where the screw shaft 25 is rotated with use of the motor 26A, for example, in a clockwise direction, the rotational-movement support members 31 and 32 move closer to each other, and the paired link mechanisms 23A and 23B extend, resulting in raising of the top plate portion 21. As a result, the upper plate 11 is raised via the force sensor 13A. In contrast, in a case where the screw shaft 25 is rotated with use of the motor 26A, for example, in a counterclockwise direction, the rotational-movement support members 31 and 32 move away from each other, and the paired link mechanisms and 23A 23B contract, resulting in lowering of the top plate portion 21. As a result, the upper plate 11 is lowered via the force sensor 13A.

As illustrated in FIG. 1, the controller 16 is provided with a start switch 16A as one example of an operation section. The battery 17 is made up of, for example, a lithium-ion battery, and is configured to supply an electric power to the controller 16, the force sensors 13A to 13D, and the motors 26A to 26D.

### [Electrical Configuration of Pallet 1]

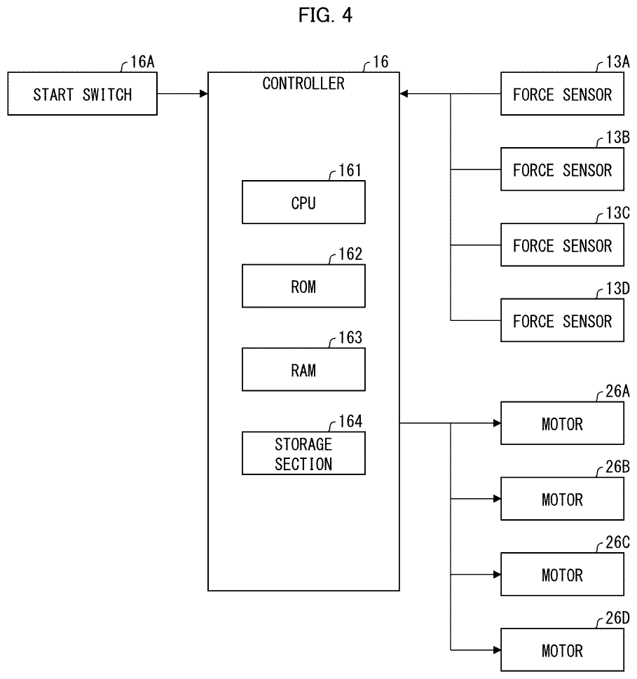

Next, with reference to FIG. 4, the following description will discuss an electrical configuration of the pallet 1. FIG. 4 is a block diagram illustrating one example of the electrical configuration of the pallet 1. As illustrated in FIG. 4, the pallet 1 includes the controller 16, the start switch 16A, the force sensors 13A to 13D, and the motors 26A to 26D.

The controller 16 is made up of, for example, a central processing unit (CPU) 161, a read only memory (ROM) 162, a random access memory (RAM) 163, a storage section 164, and the like. The storage section 164 is made up of, for example, a flash memory, a hard disk drive (HDD), or a solid state drive (SDD). The CPU 161 executes various computing processes on the basis of various programs and various parameters stored in the ROM 162. The RAM 163 temporarily stores the computing results from the CPU 161 and data of the CPU 161. The storage section 164 stores data on, for example, the center of pressure described later.

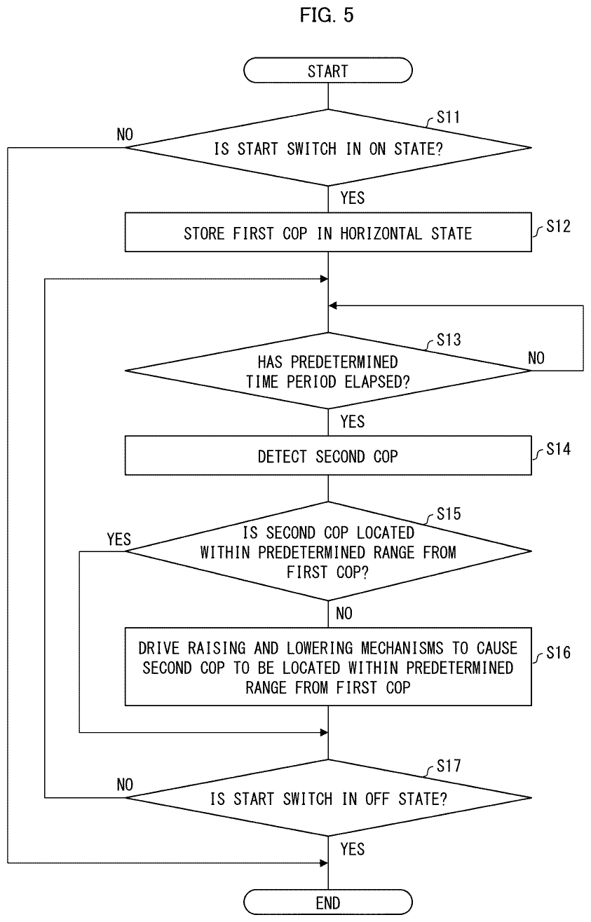

To the controller 16, the start switch 16A, the force sensors 13A to 13D, and the motors 26A to 26D are electrically connected. The start switch 16A is made up of a button switch. Pressing the button switch makes it possible to, for example, give an instruction to execute an upper-plate raising-and-lowering control process described in FIG. 5. The controller 16 stores, in the RAM 163, output signals inputted from the force sensors 13A to 13D. Further, the controller 16 performs control to drive the motors 26A to 26D to rotate so as to perform control of raising and lowering of the raising and lowering mechanisms 15A to 15D.

### [Upper-Plate Raising-and-Lowering Control Process]

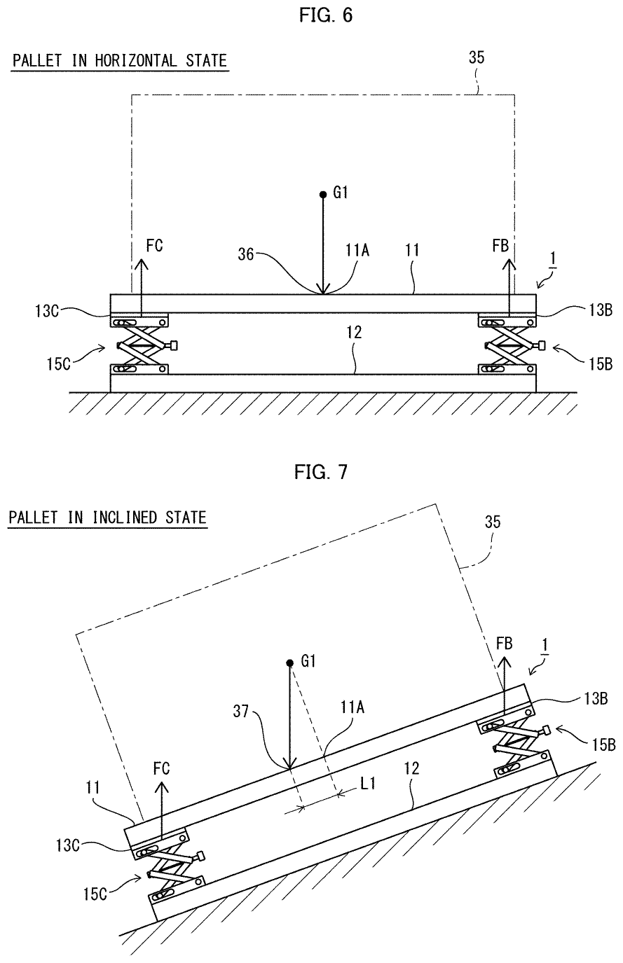

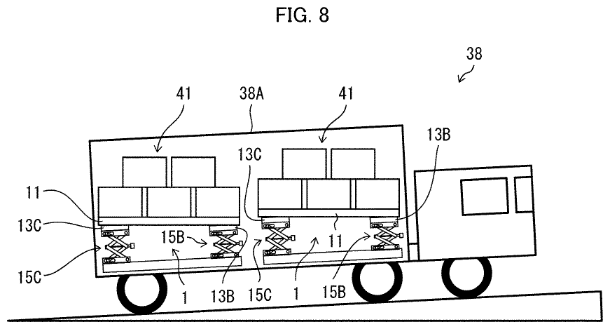

Next, with reference to FIGS. 5 to 8, the following description will discuss an example of an upper-plate raising-and-lowering control process executed by the controller 16 of the pallet 1 configured as above. FIG. 5 is a flowchart illustrating an example of the upper-plate raising-and-lowering control process executed by the controller 16. FIG. 6 is a front view illustrating an example of the center of pressure on the pallet 1 in a horizontal state. FIG. 7 is a front view illustrating an example of the center of pressure on the pallet 1 in an inclined state. FIG. 8 is a view schematically illustrating an example of an operation of the pallet 1 placed on a loading space 38A of a truck 38.

As illustrated in FIG. 5, in the step S11, the controller 16 determines whether or not the start switch 16A has been pressed to turn to an ON state. In a case where the controller 16 determines that the start switch 16A has not been pressed and is in an OFF state (S11: NO), the controller 16 ends the upper-plate raising-and-lowering control process. In contrast, in a case where the controller 16 determines that the start switch 16A has been pressed to turn to an ON state (S11: YES), the controller 16 proceeds to the process of a step S12.

In the step S12, the controller 16 detects the force components FX, FY, and FZ (output signals outputted when the pallet 1 is in a horizontal state) in the three axis directions which act on each of the force sensors 13A to 13D from a load placed with the pallet 1 in a horizontal state, that is, a load placed on the upper plate 11 of the pallet 1 provided horizontally. The controller 16 then calculates forces FA, FB, FC, and FD which respectively act on the force sensors 13A to 13D, from the force components FX, FY, and FZ in the three axis directions on each of the force sensors 13A to 13D. Subsequently, the controller 16 calculates a position on the upper plate 11 in which the sum F1=FA+FB+FC+FD of the forces FA, FB, FC, and FD acts, and stores, in the storage section 164, the position as a first center of pressure (COP) 36 of the load placed on the upper plate 11. After that, the controller 16 proceeds to the process of a step S13.

The controller 16 detects the force components FX, FY, and FZ in the three axis directions which act on each of the force sensors 13A to 13D from a load 35 placed on the upper plate 11 of the pallet 1 provided horizontally, for example, as illustrated in FIG. 6. The controller 16 then calculates forces FA, FB, FC, and FD which respectively act on the force sensors 13A to 13D, from the force components FX, FY, and FZ in the three axis directions on each of the force sensors 13A to 13D.

Subsequently, the controller 16 calculates a position on the upper plate 11 in which the sum F1=FA+FB+FC+FD of the forces FA, FB, FC, and FD acts, and stores, in the storage section 164, the position as the first COP 36 of the load 35 placed on the upper plate 11. Note that as illustrated in FIG. 2 and FIG. 6, in a case where the center of gravity G1 of the load 35 is located on a perpendicular passing an intersection of the diagonal lines of the upper plate 11, that is, passing a center position 11A of the upper plate 11, the first COP 36 coincides with the center position 11A of the upper plate 11.

As illustrated in FIG. 5, in the step S13, the controller 16 determines whether or not the current time point is a timing at which a predetermined time period, for example, approximately one second to five seconds has elapsed from when the process of the step S13 had been started. In a case where the controller 16 determines that the current time point is not the timing at which the predetermined time period has elapsed (S13: NO), the controller 16 executes the process of the step S13 again. In contrast, in a case where the controller 16 determines that the current time point is the timing at which the predetermined time period has elapsed (S13: YES), the controller 16 proceeds to the process of a step S14.

In the step S14, the controller 16 detects the force components FX, FY, and FZ (current output signals) in the three axis directions which act on each of the force sensors 13A to 13D from the load placed on the upper plate 11 of the pallet 1. The controller 16 then calculates forces FA, FB, FC, and FD which respectively act on the force sensors 13A to 13D, from the force components FX, FY, and FZ in the three axis directions on each of the force sensors 13A to 13D. Subsequently, the controller 16 calculates a position on the upper plate 11 in which the sum F2=FA+FB+FC+FD of the forces FA, FB, FC, and FD acts, and stores, in the storage section 164, the position as a second center of pressure (COP) 37 of the load placed on the upper plate 11. After that, the controller 16 proceeds to the process of a step S15.

The controller 16 detects the force components FX, FY, and FZ in the three axis directions which act on each of the force sensors 13A to 13D from the load 35 placed on the upper plate 11 of the pallet 1 provided in an inclined state, for example, as illustrated in FIG. 7. The controller 16 then calculates forces FA, FB, FC, and FD which respectively act on the force sensors 13A to 13D, from the force components FX, FY, and FZ in the three axis directions on each of the force sensors 13A to 13D.

Subsequently, the controller 16 calculates a position on the upper plate 11 in which the sum F2=FA+FB+FC+FD of the forces FA, FB, FC, and FD acts, and stores, in the storage section 164, the position as the second COP 37 of the load 35 placed on the upper plate 11. Note that as illustrated in FIG. 2 and FIG. 7, in a case where the center of gravity G1 of the load 35 is located on a perpendicular passing the intersection of the diagonal lines of the upper plate 11, that is, passing the center position 11A of the upper plate 11, the second COP 37 is located away from the center position 11A of the upper plate 11 by a distance L1.

As illustrated in FIG. 5, in the step S15, the controller 16 reads the first COP 36 and the second COP 37 from the storage section 164. The controller 16 then determines whether or not the second COP 37 is located within a predetermined range, e.g., a circle with a radius of approximately 1 cm to 3 cm, including the first COP 36 as the center thereof. For example, as illustrated in FIG. 2 and FIG. 7, in a case where the center of gravity G1 of the load 35 is located on a perpendicular passing the center position 11A of the upper plate 11, the controller 16 determines whether or not the second COP 37 is located within a circle 39 including the center position 11A of the upper plate 11 as the center thereof. Note that the predetermined range including the first COP 36 as the center thereof is not limited to a circular shape, and may be a polygonal shape, such as a quadrangular shape, a pentagonal shape, or a hexagonal shape.

In a case where the controller 16 determines that the second COP 37 is located within the predetermined range including the first COP 36 as the center thereof (S15: YES), the controller 16 proceeds to the process of a S17 described later without changing the inclination of the upper plate 11. In contrast, in a case where the controller 16 determines that the second COP 37 is not located within the predetermined range including the first COP 36 as the center thereof (S15: NO), the controller 16 proceeds to the process of a step S16 in order to make the inclination of the upper plate 11 of the pallet 1 closer to horizontal.

In the step S16, the controller 16 drives the raising and lowering mechanisms 15A to 15D to make the upper plate 11 closer to horizontal so as to cause the second COP 37 to be located within the predetermined range including the first COP 36 as the center thereof, and then proceeds to the process of the step S17. Specifically, the controller 16 drives the motors 26A to 26D of the raising and lowering mechanisms 15A to 15D to rotate so as to drive the screw shafts 25 to rotate in a clockwise or counterclockwise direction, so that the corner portions of the upper plate 11 are raised or lowered via the force sensors 13A to 13D. This makes it possible to eliminate the inclination of the load on the upper plate 11 of the pallet 1 and thus to prevent load shifting.

For example, in a case where as illustrated in FIG. 8, the truck 38 carrying, on the loading space 38A, the pallet 1 on which loads 41 are placed travels on a sloping road, stops on a sloping road, or is parked on a sloping road, for example, the controller 16 drives the raising and lowering mechanisms 15A to 15D to make the upper plate 11 closer to horizontal. Note that to the motors 26A to 26D of the raising and lowering mechanisms 15A to 15D of the pallet 1 carried on the loading space 38A of the truck 38, electric power may be supplied from an unillustrated battery mounted to the truck 38, instead of the battery 17.

Specifically, the controller 16 drives the motors 26A and 26B of the raising and lowering mechanisms 15A and 15B on a front side (on a side of a traveling direction of the truck 38) to rotate so as to drive the screw shafts 25 thereof to rotate in a counterclockwise direction. By doing so, the controller 16 causes the both front corner portions of the upper plate 11 to be lowered via the force sensors 13A and 13B. Further, the controller 16 drives the motors 26C and 26D of the raising and lowering mechanisms 15C and 15D to rotate so as to drive the screw shafts 25 thereof to rotate in a clockwise direction. By doing so, the controller 16 causes the both corner portions of the upper plate 11 on a rear side (a side opposite to the traveling direction of the truck 38) to be raised via the force sensors 13C and 13D so as to make the upper plate 11 closer to horizontal.

As illustrated in FIG. 5, in the step S17, the controller 16 determines whether or not the start switch 16A has been pressed to turn to an OFF state. In a case where the controller 16 determines that the start switch 16A has not been pressed and is in an ON state (S17: NO), the controller 16 executes the process of the step S13 and the subsequent processes again. In contrast, in a case where the controller 16 determines that the start switch 16A has been pressed to turn to an OFF state (S17: YES), the controller 16 ends the upper-plate raising-and-lowering control process.

As described above in detail, in the pallet 1 in accordance with Embodiment 1, the controller 16 calculates the first COP 36 on the upper plate 11 of the pallet 1 in a horizontal state on the basis of output signals from the force sensors 13A to 13D. The controller 16 then calculates the second COP 37 on the upper plate 11 of the pallet 1 on the basis of output signals from the force sensors 13A to 13D each time a predetermined time period elapses.

In a case where the controller 16 determines that the second COP 37 is not located within a predetermined range from the first COP 36, the controller 16 performs control to drive the motors 26A to 26D of the raising and lowering mechanisms 15A to 15D so as to cause the second COP 37 to be located within the predetermined range from the first COP 36. This enables the controller 16 to make the upper plate 11 closer to a horizontal state and thus to prevent load shifting on the pallet 1.

### Embodiment 2

### [Schematic Configuration of Loading System 100]

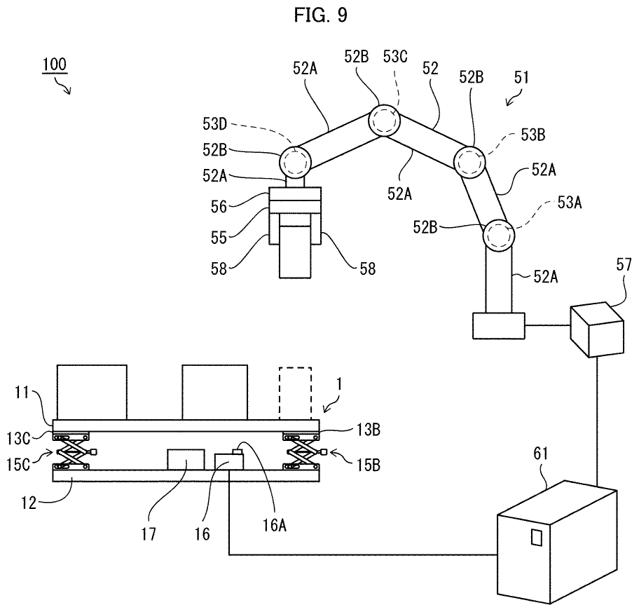

Next, with reference to FIG. 9, the following discuss a loading system 100 in description will accordance with Embodiment 2 of the present disclosure. FIG. 9 is an explanatory view for explaining a schematic configuration of the loading system 100 in accordance with Embodiment 2. For convenience of description, a member having a function identical to that of a member discussed in Embodiment 1 is given an identical reference sign, and a description thereof is omitted.

As illustrated in FIG. 9, the loading system 100 includes the pallet 1 in accordance with Embodiment 1, a robot 51, and a loading control device 61. The robot 51 includes a robot arm 52, a robot hand 55, a hand force sensor 56, and a robot controller 57. The robot arm 52 is an articulated arm including a plurality of arms 52A. In the robot arm 52, the five arms 52A are connected by four joints 52B.

The respective joints 52B include a first joint motor 53A, a second joint motor 53B, a third joint motor 53C, and a fourth joint motor 53D which are configured to operate the respective joints 52B. However, the number of arms 52A included in the robot arm 52 is not limited to only five, and the number of joints 52B connecting the arms 52A is not limited to only four.

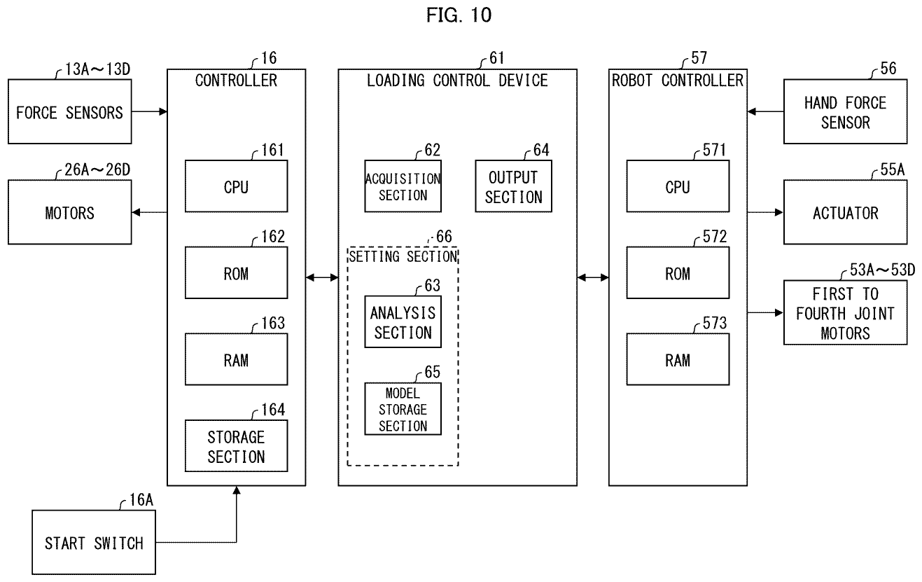

The robot hand 55 is configured to be able to hold a load with two claws 58 which are operated to open and close by an actuator 55A illustrated in FIG. 10. The robot hand 55 is mounted to the robot arm 52 via a hand force sensor 56. The robot arm 52 has six degrees of freedom, and supports the robot hand 55 in such a manner as to allow the robot hand 55 to change its position and its posture.

The hand force sensor 56 detects directions and magnitudes of forces and moments that act on the hand force sensor 56. The hand force sensor 56 is a six-axis force sensor that detects force components FX, FY, and FZ in the directions of the three axes, namely, the X-, Y-, and Z-axes of a force sensor coordinate system in which the axis direction corresponds to the Z-axis direction and moment components MX, MY, and MZ around the rotational axes which are the three axes, namely, the X-, Y-, and Z-axes. The hand force sensor 56 and the robot hand 55 are disposed so as to be coaxial.

Thus, the hand force sensor 56 detects the following components acting on the robot hand 55: the force components FX, FY, and FZ in the directions of the three axes, namely, the X-, Y-, and Z-axes and the moment components MX, MY, and MZ around the rotational axes which are the three axes, namely, the X-, Y-, and Z-axes. Hereinafter, FX, FY, FZ, MX, MY, and MZ will also be referred to as force components or simply as detected values. The hand force sensor 56 outputs a signal related to the detected values to the robot controller 57.

### [Electrical Configuration of Robot Controller 57]

Next, with reference to FIG. 10, the following will discuss an electrical configuration of the robot controller 57. FIG. 10 is a block diagram illustrating one example of the electrical configuration of the loading system 100. As illustrated in FIG. 10, the robot controller 57 is made up of, for example, a central processing unit (CPU) 571, a read only memory (ROM) 572, a random access memory (RAM) 573, and the like. The CPU 571 executes various computing processes on the basis of various programs and various parameters stored in the ROM 572. The RAM 573 temporarily stores the computing results from the CPU 571 and data of the CPU 571.

To the robot controller 57, the hand force sensor 56, the actuator 55A configured to operate the two claws 58 of the robot hand 55 to open and close, and the first joint motor 53A to fourth joint motor 53D are electrically connected. Further, the robot controller 57 is configured to be communicable with the loading control device 61 in a wired or wireless manner.

When the robot controller 57 receives a transmission request instruction from the loading control device 61, the robot controller 57 transmits, to the loading control device 61, a detection signal from the hand force sensor 56. Further, when receiving the various operation instructions from the loading control device 61, the robot controller 57 performs control to drive the actuator 55A and the first joint motor 53A to fourth joint motor 53D in accordance with the various programs stored in the ROM 572.

### [Electrical Configuration of Loading Control Device 61]

The loading control device 61 is configured to be communicable with the controller 16 of the pallet 1 and the robot controller 57 in a wired or wireless manner. Note that the loading control device 61, the controller 16, and the robot controller 57 may be connected to a network, such as the Internet or LAN. Further, the loading control device 61 may communicate with the controller 16 and the robot controller 57 via the network.

The loading control device 61 sets a placement position in which a load held by the robot hand 55 is to be placed on the upper plate 11, on the basis of the center of pressure (third center of pressure) of a load placed on the upper plate 11 of the pallet 1, the weight of the load held by the robot hand 55, and the center of gravity of the load held by the robot hand 55. The loading control device 61 then performs control to cause the robot 51 to place the load in the placement position on the upper plate 11.

With reference to FIG. 10, the following description will discuss an electrical configuration of the loading control device 61. As illustrated in FIG. 10, the loading control device 61 includes an acquisition section 62, an analysis section 63, an output section 64, and a model storage section 65. The analysis section 63 and the model storage section 65 make up a setting section 66 configured to set a placement position of a load.

The acquisition section 62 requests that the controller 16 of the pallet 1 calculate and transmit the center of pressure of a load placed on the upper plate 11. The acquisition section 62 then acquires the center of pressure of the load placed on the upper plate 11, from the controller 16. The acquisition section 62 receives, from the robot controller 57, the detection signal indicating the following components from the hand force sensor 56: the force components FX, FY, and FZ in the three axis directions; and the moment components MX, MY, and MZ around the rotational axes which are the three axes, namely, the X-, Y-, and Z-axes. The acquisition section 62 then acquires the weight and the center of gravity of the load held by the robot hand 55, from the following components from the hand force sensor 56: the force components FX, FY, and FZ in the three axis directions; and the moment components MX, MY, and MZ around the rotational axes which are the three axes, namely, the X-, Y-, and Z-axes.

The analysis section 63 infers the placement position in which the load held by the robot hand 55 is to be placed on the upper plate 11, by inputting, to a learned model stored in the model storage section 65, the weight of the load, the center of gravity of the load, and the center of pressure of the load placed on the upper plate 11 of the pallet 1, the weight, the center of gravity, and the center of pressure having been acquired by the acquisition section 62. The output section 64 transmits the placement position of the load on the upper plate 11 which has been inferred by the analysis section 63, to the robot controller 57 as the placement position in which the load held by the robot hand 55 is to be placed on the upper plate 11, and gives an instruction to place the load on the upper plate 11. In addition, the output section 64 outputs various request instructions to the robot controller 57.

The model storage section 65 stores a learned model generated by an unillustrated model generation device. The learned model is generated through machine learning using, as training data, a weight of a load held by the robot hand 55, the center of gravity of the load, the center of pressure on the upper plate 11 of the pallet 1, and a placement position in which a load held by the robot hand 55 is placed on the upper plate 11 so as to cause a position of the center of pressure to be closer to the center position 11A of the upper plate 11. Therefore, the learned model is a model learned so as to, when a weight of a load held by the robot hand 55, the center of gravity of the load, and the center of pressure on the upper plate 11 of the pallet 1 are inputted, output a placement position in which the load held by the robot hand 55 is placed on the upper plate 11 so as to cause the position of the center of pressure on the upper plate 11 to be closer to the center position 11A of the upper plate 11.

### [Loading Control Process]

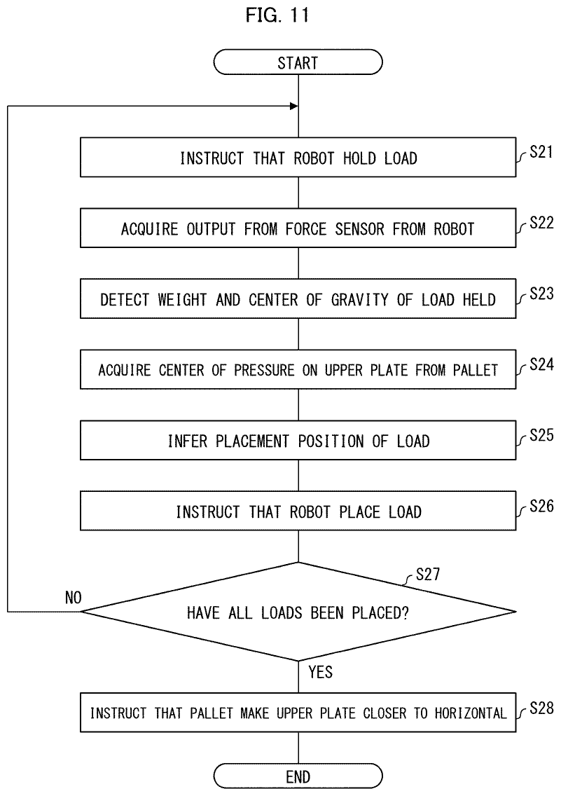

Next, with reference to FIG. 11, the following description will discuss a loading control process of placing a load on the upper plate 11 of the pallet 1 with use of the robot 51, the loading control process being executed by the loading control device 61 of the loading system 100 configured as above. FIG. 11 is a flowchart illustrating an example of the loading control process executed by the loading control device 61. When an instruction to load a load on the upper plate 11 is inputted by a user to the loading control device 61, the loading control device 61 executes the loading control process illustrated in FIG. 11. The program shown by the flowchart in FIG. 11 is stored in advance in an unillustrated ROM.

As illustrated in FIG. 11, in the step S21, the loading control device 61 outputs a load holding instruction to hold a load to be placed on the upper plate 11, to the robot controller 57 via the output section 64, and then proceeds to the process of a step S22. This enables the loading control device 61 to instruct that the robot 51 hold the load to be placed on the upper plate 11 with use of the robot hand 55.

In the step S22, the loading control device 61 instructs, via the output section 64, that the robot controller 57 transmit a detection signal indicating the following components from the hand force sensor 56: the force components FX, FY, and FZ in the three axis directions; and the moment components MX, MY, and MZ around the rotational axes which are the three axes, namely, the X-, Y-, and Z-axes. The loading control device 61 then acquires, via the acquisition section 62, the following components from the hand force sensor 56: the force components FX, FY, and FZ in the three axis directions; and the moment components MX, MY, and MZ around the rotational axes which are the three axes, namely, the X-, Y-, and Z-axes, and then proceeds to the process of a step S23.

In the step S23, the loading control device 61 detects, via the acquisition section 62, the weight and the center of gravity of the load held by the robot hand 55, from the following components from the hand force sensor 56: the force components FX, FY, and FZ in the three axis directions; and the moment components MX, MY, and MZ around the rotational axes which are the three axes, namely, the X-, Y-, and Z-axes. After that, the loading control device 61 proceeds to the process of a step S24.

In the step S24, the loading control device 61 transmits, via the acquisition section 62, a transmission instruction to calculate and transmit the center of pressure of a load placed on the upper plate 11, to the controller 16 of the pallet 1. The loading control device 61 then receives the center of pressure of the load placed on the upper plate 11, from the controller 16 via the acquisition section 62, and then proceeds to the process of a step S25.

In the step S25, the loading control device 61 inputs, via the analysis section 63, the weight and the center of gravity of the load held by the robot hand 55 which have been detected in the step S23, and the center of pressure of the load placed on the upper plate 11 of the pallet 1 which has been acquired in the step S24, to the learned model stored in the model storage section 65. The loading control device 61 then infers a placement position outputted from the learned model, as the placement position in which the load held by the robot hand 55 is to be placed on the upper plate 11, and then proceeds to the process of a step S26.

In the step S26, the loading control device 61 transmits, via the output section 64, a load placing instruction including the placement position in which the load held by the robot hand 55 is to be placed on the upper plate 11 and which has been inferred in the step S25, to the robot controller 57, and then proceeds to the process of a step S27. This enables the loading control device 61 to instruct the robot 51 where the load is to be placed and to place the load on the upper plate 11.

In the step S27, the loading control device 61 determines whether or not all the loads have been placed on the upper plate 11. In a case where the loading control device 61 determines that all the loads have not been placed on the upper plate 11 (S27: NO), the loading control device 61 executes the process of the S21 and the subsequent processes again. In contrast, in a case where the loading control device 61 determines that all the loads have been placed on the upper plate 11 (S27: YES), the loading control device 61 proceeds to the process of a step S28.

In the step S28, the loading control device 61 transmits, via the output section 64, a horizontality instruction to make the upper plate 11 closer to horizontal, to the controller 16 of the pallet 1, and then ends the loading control process. This enables the center of pressure of the upper plate 11 of the pallet 1 to become closer to the center position 11A of the upper plate 11, thereby making it possible to prevent load shifting.

### [Force-Sensor Output Process]

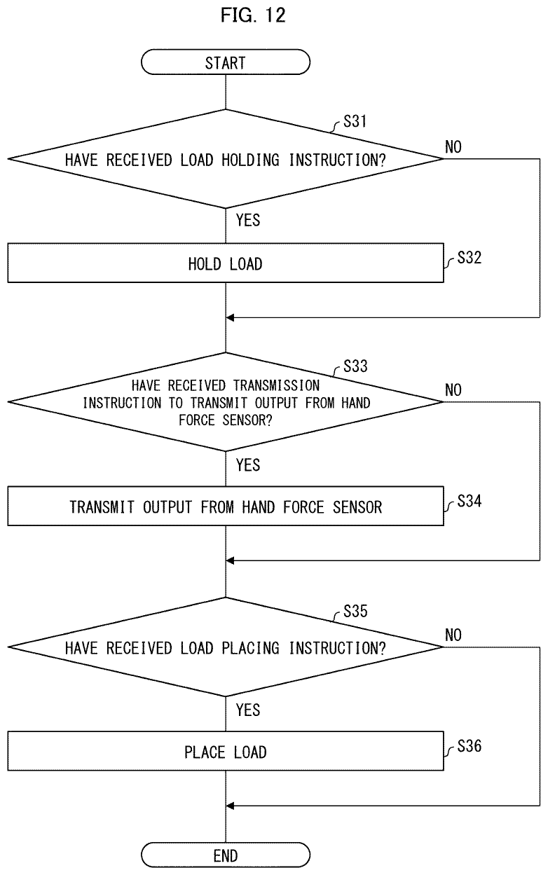

Next, with reference to FIG. 12, the following description will discuss a force-sensor output process executed by the robot controller 57 of the loading system 100 configured as above. FIG. 12 is a flowchart illustrating an example of the force-sensor output process executed by the robot controller 57. The robot controller 57 executes the force-sensor output process at predetermined time intervals, for example, every approximately 0.1 seconds. The program shown by the flowchart in the FIG. 12 is stored in advance in the ROM 572.

As illustrated in FIG. 12, in the step S31, the robot controller 57 determines whether or not the robot controller 57 has received, from the loading control device 61, the load holding instruction to hold a load to be placed on the upper plate 11. In a case where the robot controller 57 determines that the robot controller 57 has not received the load holding instruction to hold the load to be placed on the upper plate 11 (S31: NO), the robot controller 57 proceeds to the process of a step S33 described later. In contrast, in a case where the robot controller 57 determines that the robot controller 57 has received the load holding instruction to hold the load to be placed on the upper plate 11 (S31: YES), the robot controller 57 proceeds to the process of a step S32.

In the step S32, the robot controller 57 performs control to drive the first joint motor 53A to fourth joint motor 53D and the actuator 55A to hold the load to be placed on the upper plate 11 with use of the robot hand 55 and slightly lift the load, and then proceeds to the process of a step S33.

In the step S33, the robot controller 57 determines whether or not the robot controller 57 has received, from the loading control device 61, the transmission instruction to transmit a detection signal indicating the following components from the hand force sensor 56: the force components FX, FY, and FZ in the three axis directions; and the moment components MX, MY, and MZ around the rotational axes which are the three axes, namely, the X-, Y-, and Z-axes.

In a case where the robot controller 57 determines that the robot controller 57 has not received, from the loading control device 61, the transmission instruction to transmit the detection signal indicating the following components from the hand force sensor 56: the force components FX, FY, and FZ in the three axes directions; and the moment components MX, MY, and MZ around the rotational axes which are the three axes, namely, the X-, Y-, and Z-axes (S33: NO), the robot controller 57 proceeds to the process of a step S35 described later.

In contrast, in a case where the robot controller 57 determines that the robot controller 57 has received, from the loading control device 61, the transmission instruction to transmit the detection signal indicating the following components from the hand force sensor 56: the force components FX, FY, and FZ in the three axis directions; and the moment components MX, MY, and MZ around the rotational axes which are the three axes, namely, the X-, Y-, and Z-axes (S33: YES), the robot controller 57 proceeds to the process of a step S34. In the step S34, the robot controller 57 transmits, to the loading control device 61, the detection signal indicating the following components from the hand force sensor 56: the force components FX, FY, and FZ in the three axis directions; and the moment components MX, MY, and MZ around the rotational axes which are the three axes, namely, the X-, Y-, and Z-axes, and then proceeds to the process of a step S35.

In the step S35, the robot controller 57 determines whether or not the robot controller 57 has received, from the loading control device 61, the load placing instruction including the placement position in which the load held by the robot hand 55 is to be placed on the upper plate 11. In a case where the robot controller 57 determines that the robot controller 57 has not received, from the loading control device 61, the load placing instruction including the placement position in which the load held by the robot hand 55 is to be placed on the upper plate 11 (S35: NO), the robot controller 57 ends the force-sensor output process.

In contrast, in a case where the robot controller 57 determines that the robot controller 57 has received, from the loading control device 61, the load placing instruction including the placement position in which the load held by the robot hand 55 is to be placed on the upper plate 11 (S35: YES), the robot controller 57 proceeds to the process of a step S36. In the step S36, the robot controller 57 places the load held by the robot hand 55 in the placement position on the upper plate 11 which is included in the load placing instruction, and then causes the robot hand 55 to move to a default position. The robot controller 57 then ends the force-sensor output process. This enables the robot controller 57 to place the load on the upper plate 11 so as to cause the center of pressure of the upper plate 11 of the pallet 1 to be closer to the center position 11A of the upper plate 11.

### [Center-of-Pressure Output Process]

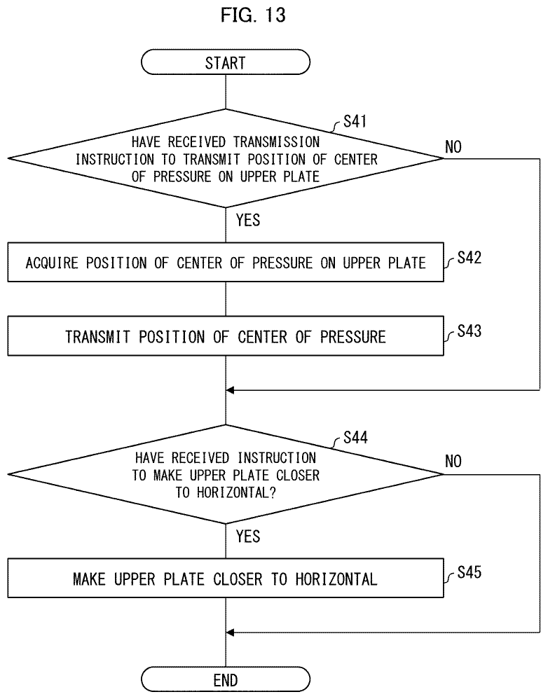

Next, with reference to FIG. 13, the following description will discuss a center-of-pressure output process executed by the controller 16 of the pallet 1 of the loading system 100 configured as above. FIG. 13 is a flowchart illustrating an example of the center-of-pressure output process executed by the controller 16 of the pallet 1. Note that the controller 16 executes the center-of-pressure output process at predetermined time intervals, for example, every approximately 0.1 seconds. The program shown by the flowchart in FIG. 13 is stored in advance in the ROM 162.

As illustrated in FIG. 13, in the step S41, the controller 16 determines whether or not the controller 16 has received, from the loading control device 61, the transmission instruction to calculate and transmit the center of pressure of a load placed on the upper plate 11. In a case where the controller 16 determines that the controller 16 has not received, from the loading control device 61, the transmission instruction to calculate and transmit the center of pressure of the load placed on the upper plate 11 (S41: NO), the controller 16 proceeds to the process of a step S44 described later. In contrast, in a case where the controller 16 determines that the controller 16 has received, from the loading control device 61, the transmission instruction to calculate and transmit the center of pressure of the load placed on the upper plate 11 (S41: YES), the controller 16 proceeds to the process of a step S42.

In the step S42, the controller 16 detects the force components FX, FY, and FZ in the three axis directions which act on each of the force sensors 13A to 13D from the load placed on the upper plate 11 of the pallet 1. The controller 16 then calculates the forces FA, FB, FC, and FD which respectively act on the force sensors 13A to 13D, from the force components FX, FY, and FZ in the three axis directions on each of the force sensors 13A to 13D. Subsequently, the controller 16 calculates a position on the upper plate 11 in which the sum F3=FA+FB+FC+FD of the forces FA, FB, FC, and FD acts, and stores, in the storage section 164, the position as the center of pressure (third center of pressure) of the load placed on the upper plate 11. After that, the controller 16 proceeds to the process of a step S43.

In the step S43, the controller 16 reads the center of pressure of the load placed on the upper plate 11, from the storage section 164, and then transmits positional information on this center of pressure to the loading control device 61, followed by proceeding to the process of a step S44.

In the step S44, the controller 16 determines whether or not the controller 16 has received, from the loading control device 61, the horizontality instruction to make the upper plate 11 closer to horizontal. In a case where the controller 16 determines that the controller 16 has not received, from the loading control device 61, the horizontality instruction to make the upper plate 11 closer to horizontal (S44: NO), the controller 16 ends the center-of-pressure output process.

In contrast, in a case where the controller 16 determines that the controller 16 has received, from the loading control device 61, the horizontality instruction to make the upper plate 11 closer to horizontal (S44: YES), the controller 16 proceeds to the process of a step S45.

In the step S45, the controller 16 detects the force components FX, FY, and FZ in the three axis directions which act on each of the force sensors 13A to 13D from the load placed on the upper plate 11 of the pallet 1. The controller 16 then calculates the forces FA, FB, FC, and FD which respectively act on the force sensors 13A to 13D, from the force components FX, FY, and FZ in the three axis directions on each of the force sensors 13A to 13D.

Subsequently, the controller 16 calculates a position on the upper plate 11 in which the sum F4=FA+FB+FC+FD of the forces FA, FB, FC, and FD acts, and stores, in the storage section 164, the position as the center of pressure of the load placed on the upper plate 11. The controller 16 drives the raising and lowering mechanisms 15A to 15D to cause this center of pressure to be located within a predetermined range, e.g., a circle with a radius of approximately 2 cm to 4 cm, including the center position 11A of the upper plate 11 of the pallet 1 as the center thereof, to make the upper plate 11 closer to horizontal. The controller 16 then ends the center-of-pressure output process. This makes it possible to prevent load shifting of a load placed on the upper plate 11 of the pallet 1.

As described above in detail, in the loading system 100 in accordance with Embodiment 2, the loading control device 61 sets the placement position in which a load held by the robot hand 55 is to be placed on the upper plate 11, on the basis of the weight of the load held by the robot hand 55, the center of gravity of the load, and the center of pressure of the load placed on the upper plate 11. This makes it possible to cause the center of pressure on the upper plate 11 to be closer to the center position 11A of the upper plate 11 and thus to prevent load shifting on the pallet 1.

Further, the load held by the robot hand 55 is placed in a placement position on the upper plate 11 which has been inferred by the analysis section 63 of the loading control device 61, thereby causing the center of pressure on the upper plate 11 of the pallet 1 to be closer to the center position 11A of the upper plate 11. This makes it possible to prevent load shifting on the pallet 1. Furthermore, the robot controller 57 can perform control to drive the robot hand 55 and the robot arm 52, thereby making it possible to ease a process executed by the loading control device 61.

### [Variation 1]

In the pallet 1 in accordance with Embodiment 1 above, the four force sensors 13A to 13D and the four raising and lowering mechanisms 15A to 15D are provided, but it is also possible that three force sensors and three raising and lowering mechanisms are provided or that five or more force sensors and five or more raising and lowering mechanisms are provided.

For example, the force sensors 13A and 13B may be attached to the corner portions at the both ends of one side edge portion of the lower surface of the upper plate 11 of the pallet 1, and the force sensor 13C may be attached to the substantially center position of another side edge portion facing the one side edge portion. Further, the three raising and lowering mechanisms 15A to 15 C may be attached between the three force sensors 13A to 13C and the upper surface of the lower frame 12. This enables the controller 16 to acquire the center of pressure of a load placed on the upper plate 11 on the basis of output signals from the three force sensors 13A to 13C. In addition, this enables the controller 16 to make the upper plate 11 closer to a horizontal state by driving the motors 26A to 26C of the three raising and lowering mechanisms 15A to 15C.

### [Variation 2]

For example, in the pallet 1 in accordance with Embodiment 1 above, the force sensors 13A to 13D may be attached to the four corners of the upper surface of the lower frame 12. Further, the raising and lowering mechanisms 15A to 15D may be attached between the force sensors 13A to 13D and the four corners of the lower surface of the upper plate 11. This enables the controller 16 to acquire the center of pressure of a load placed on the upper plate 11, on the basis of output signals from the force sensors 13A to 13D. In addition, this enables the controller 16 to make the upper plate 11 closer to a horizontal state by driving the motors 26A to 26D of the raising and lowering mechanisms 15A to 15D.

### [Variation 3]

For example, in the pallet 1 in accordance with Embodiment 1 above, the lower frame 12 may be made up of a frame member having a rectangular shape in plan view and a crosspiece having a cross shape and bridging across the substantially center portions of the side edge portions of the frame member which face each other. This makes it possible to reduce the weight of the pallet 1.

### [Variation 4]

For example, the force sensors 13A to 13D may each have a substantially circular shape in plan view.

### [Variation 5]

For example, in the pallet 1 in accordance with Embodiment 1 above, to each of the four corners of the upper surface of the lower frame 12, a plate-shaped rubber with a rectangular shape in plan view which has a size substantially identical with that of the bottom plate portion 22 of each of the raising and lowering mechanisms 15A to 15D and has, for example, a thickness of approximately 2 cm to 4 cm may be attached as a buffer member. Further, the bottom plate portion 22 of each of the raising and lowering mechanisms 15A to 15D may be attached to the upper surface of a buffer member, such as the plate-shaped rubber. When an impact force in a direction orthogonal to the up-and-down direction acts on each of the raising and lowering mechanisms 15A to 15D, the above configuration makes it possible to weaken the impact force with use of the buffer member, such as the plate-shaped rubber and thus to prevent damage to the lower frame 2 and the raising and lowering mechanisms 15A to 15D.

### ADDITIONAL REMARK

The present disclosure is not limited to the embodiments and variations described above, but can be altered by a skilled person in the art within the scope of the claims. The present disclosure also encompasses in its technical scope any embodiment based on an appropriate combination of the technical means disclosed in different embodiments and variations.

### SUPPLEMENTARY REMARKS

A pallet in accordance with Aspect 1 includes: an upper plate on which a load is to be placed; a lower frame disposed so as to face the upper plate; at least three force sensors disposed on a lower surface of the upper plate or an upper surface of the lower frame; at least three raising and lowering mechanisms that are disposed between the upper plate and the lower frame via the at least three force sensors and that are able to raise and lower the upper plate with respect to the lower frame; and a controller configured to perform control to drive the at least three raising and lowering mechanisms on the basis of output signals from the at least three force sensors.

According to the pallet in accordance with Aspect 1, the controller makes it possible to, in a case where the pallet in which a load is placed on the upper plate inclines, make the upper plate closer to a horizontal state by performing control to drive the at least three raising and lowering mechanisms on the basis of output signals from the at least three force sensors. As a result, the controller makes it possible to prevent load shifting in a case where the pallet inclines.

A pallet in accordance with Aspect 2 is the pallet in accordance with Aspect 1 configured such that the controller performs control to drive the at least three raising and lowering mechanisms so as to make the upper plate closer to horizontal, on the basis of output signals outputted from the at least three force sensors when the upper plate is in a horizontal state and current output signals from the at least three force sensors.

According to the pallet in accordance with Aspect 2, the controller makes the upper plate closer to horizontal by performing control to drive the at least three raising and lowering mechanisms on the basis of the output signals outputted from the at least three force sensors when the upper plate is in a horizontal state and the current output signals from the at least three force sensors. This enables the controller to, in a case where the pallet inclines, make the upper plate closer to horizontal, and thus to further prevent load shifting on the pallet.

A loading system in accordance with Aspect 3 includes: the pallet in accordance with Aspect 1 or 2; a robot in which a robot hand is attached to a tip end portion of a robot arm via a hand force sensor; and a loading control device configured to perform control to cause the robot to place a load on the upper plate of the pallet, the loading control device including a setting section configured to set a placement position in which the load held by the robot hand is to be placed on the upper plate, on the basis of an output signal from the hand force sensor and an output signal from each of the at least three force sensors or the controller, the loading control device controlling the robot so that the load held by the robot hand is placed in the placement position on the upper plate, the placement position having been set by the setting section.

According to the loading system in accordance with Aspect 3, the loading control device sets the placement position in which the load held by the robot hand is to be placed on the upper plate, on the basis of an output signal from the hand force sensor and an output signal from each of the at least three force sensors or the controller. This makes it possible to cause the center of pressure on the upper plate to be closer to the center position of the upper plate and thus to prevent load shifting on the pallet.

A loading system in accordance with Aspect 4 is the loading system in accordance with Aspect 3 configured such that the setting section uses a learned model generated through machine learning to set the placement position in which the load held by the robot hand is to be placed on the upper plate.

According to the loading system in accordance with Aspect 4, the placement position in which the load held by the robot hand is to be placed is set with use of the learned model generated through machine learning. This makes it possible to further cause the center of pressure on the upper plate to be closer to the center position of the upper plate and thus to prevent load shifting on the pallet.

1. A pallet comprising:
an upper plate on which a load is to be placed;
a lower frame disposed so as to face the upper plate;
at least three force sensors disposed on a lower surface of the upper plate or an upper surface of the lower frame;
at least three raising and lowering mechanisms that are disposed between the upper plate and the lower frame via the at least three force sensors and that are able to raise and lower the upper plate with respect to the lower frame; and
a controller configured to perform control to drive the at least three raising and lowering mechanisms on the basis of output signals from the at least three force sensors.

2. The pallet according to claim 1, wherein the controller performs control to drive the at least three raising and lowering mechanisms so as to make the upper plate closer to horizontal, on the basis of output signals outputted from the at least three force sensors when the upper plate is in a horizontal state and current output signals from the at least three force sensors.

3. A loading system comprising:
a pallet;
a robot in which a robot hand is attached to a tip end portion of a robot arm via a hand force sensor; and
a loading control device configured to perform control to cause the robot to place a load on the pallet,
the pallet comprising:
an upper plate on which a load is to be placed;
a lower frame disposed so as to face the upper plate;
at least three force sensors disposed on a lower surface of the upper plate or an upper surface of the lower frame;
at least three raising and lowering mechanisms that are disposed between the upper plate and the lower frame via the at least three force sensors and that are able to raise and lower the upper plate with respect to the lower frame; and
a controller configured to perform control to drive the at least three raising and lowering mechanisms on the basis of output signals from the at least three force sensors,
the loading control device comprising a setting section configured to set a placement position in which the load held by the robot hand is to be placed on the upper plate, on the basis of an output signal from the hand force sensor and an output signal from each of the at least three force sensors or the controller,
the loading control device controlling the robot so that the load held by the robot hand is placed in the placement position on the upper plate, the placement position having been set by the setting section.

4. The loading system according to claim 3, wherein the setting section uses a learned model generated through machine learning to set the placement position in which the load held by the robot hand is to be placed on the upper plate.

5. The loading system according to claim 3, wherein the controller performs control to drive the at least three raising and lowering mechanisms so as to make the upper plate closer to horizontal, on the basis of output signals outputted from the at least three force sensors when the upper plate is in a horizontal state and current output signals from the at least three force sensors.

6. The loading system according to claim 5, wherein the setting section uses a learned model generated through machine learning to set the placement position in which the load held by the robot hand is to be placed on the upper plate.
